(19) United States
(12) Patent Application Publication
(10) Pub. No.: US 2023/0193105 A1
(43) Pub. Date: Jun. 22, 2023

(54) THERMALLY CONDUCTIVE POLYURETHANE COMPOSITION

(71) Applicants: Dow Global Technologies LLC, Midland, MI (US); Dow Silicones Corporation, Midland, MI (US)

(72) Inventors: Yu Chen, Shanghai (CN); Darren Hansen, Auburn, MI (US); Qingwei Meng, Shanghai (CN); Chong Xing, Shanghai (CN); Tingting Chen, Shanghai (CN); Shaoguang Feng, Shanghai (CN)

(21) Appl. No.: 17/926,352

(22) PCT Filed: Jun. 29, 2020
(86) PCT No.: PCT/CN2020/098835

§ 371 Date: Nov. 18, 2022

(51) Int. Cl. C09K 5/14; C08K 13/06; C08G 18/76; C08G 18/36; C08G 18/48; C08G 18/32; C08G 18/66

(52) U.S. Cl. CPC C09K 5/14; C08K 13/06; C08G 18/7671; C08G 18/36; C08G 18/4829; C08G 18/3206; C08G 18/6696; C08K 2201/001; C08K 7/18

(57) ABSTRACT

A composition comprising an isocyanate composition comprising a polyisocyanate and a specific thermally conductive filler composition (C) can further be part of a two-component curable composition comprising the isocyanate composition and a polyol composition and having a low viscosity upon admixing and upon cure provides a high thermal conductivity.

### FIELD OF THE INVENTION

The present invention is a two-component thermally conductive polyurethane composition and a process of preparing the same.

### INTRODUCTION

Two-component polyurethane (PU) adhesives or gap fillers comprising a polyol component and an isocyanate component are becoming important in the industry, but still suffer from limitations such as insufficient thermal conductivity. For example, some applications such as gap fillers for battery packs need a high thermal conductivity of at least 2.73 Watts per meter Kelvin (W/mK), preferably 3.0 W/mK or higher as measured according to ISO 22007-2. There are challenges for improving thermal conductivity while maintaining processability including, for example, flowability and manufacturing facilities.

Incorporation of sufficient amounts of thermally conductive fillers to conventional two-component PU adhesives may reach the above thermal conductivity requirement but the viscosity of the resultant highly filled system is difficult to achieve while also achieving a formulation viscosity of 230 pascal-seconds (Pa·s) at room temperature (23±2 degrees Celsius (° C.)) when measured within 30 minutes of mixing the two components of the adhesive together. Therefore, it is challenging for two-component PU compositions to reach the required high thermal conductivity while maintaining the low viscosity for easy processability and application.

Moreover, due to the sensitivity of isocyanates to moisture from fillers, only limited types and amounts of fillers can be introduced into the isocyanate part, for example, typical thermally conductive fillers such as amorphous alumina are not able to be included in the isocyanate component of the two-component polyurethane adhesive. These issues not only limit the total amount of thermally conductive fillers that can be included in two-component PU adhesives, but also make it difficult to provide a consistent mixing ratio for the two components, i.e., a volume mixing ratio between 0.95:1 and 1.05:1. Mixing ratios outside this mixing ratio (e.g., 30:1) cause unequal flow rates of the two components, which results in performance failures and requires special equipment design for mixing each component. It is further desirable that a two-component PU composition can be produced using existing manufacturing equipment.

It is desirable to discover an isocyanate composition that comprises thermally conductive fillers yet can be used in a two-part polyurethane adhesive formulation without the aforementioned problems.

### SUMMARY OF THE INVENTION

The present invention solves the problem of discovering an isocyanate composition that comprises thermally conductive fillers yet that can be used in a two-part polyurethane adhesive formulation without the aforementioned problems.

The present invention provides a novel composition comprising an isocyanate composition that comprises a polyisocyanate and a specific thermally conductive filler composition (C). The composition of the present invention is storage stable, as indicated by the isocyanate composition having a viscosity drift of 50% or less after storage at 50° C. for 24 hours under nitrogen atmosphere. The isocyanate composition of the present invention is particularly suitable as a two-component curable composition that further comprises a polyol composition. The two-component curable composition comprises two components: the polyol composition as a component A and the isocyanate composition as a component B. The two-component curable composition has a viscosity of no more than 230 pascal-seconds (Pa·s) at room temperature (23±2° C.), as measured within 30 minutes after mixing the two components. The two-component curable composition, upon curing, also provides a polyurethane material having a thermal conductivity of 2.73 Watts per meter Kelvin (W/mK) or higher or 3.0 W/mK or higher. Moreover, the volume mixing ratio of the component A and the component B of the curable composition can be controlled between 0.95:1 to 1.05:1, thus the two-component curable composition can be prepared using existing manufacturing facilities. The properties above are measured according to the test methods described in the Examples section below.

In a first aspect, the present invention provides a composition comprising an isocyanate composition comprising a polyisocyanate and a thermally conductive filler composition (C), wherein the thermally conductive filler composition comprises:

(c1) spherical metal oxide particles with a mean particle size of 20 micrometers (μm) or more;

(c2) surface treated metal oxide particles with a mean particle size of greater than 1 μm to 10 μm, wherein the surface treated metal oxide particles are treated by an alkoxysilane; and

(c3) an additional thermally conductive filler selected from the group consisting of metal oxide particles with a mean particle size of 1 μm or less, a thermally conductive filler with a thermal conductivity of 40 W/mK or more and that is other than a metal oxide particle, or mixtures thereof.

In a second aspect, the present invention provides a process for preparing the composition of the first aspect. The process comprises admixing the components of the thermally conductive filler composition (C) with the polyisocyanate, and optionally admixing with a polyol composition.

### DETAILED DESCRIPTION OF THE INVENTION

“Polyol” refers to any compound containing two or more hydroxyl (OH) groups.

“Thermally conductive filler” refers to any filler that exhibits a thermally conductively of 10 W/mK or more, as measured according to ASTM D5470-17.

“Aspect ratio” herein refers to the ratio of minimum diameter (Dₘᵢₙ) to maximum diameter (Dₘₐₓ) (Dₘᵢₙ/Dₘₐₓ). Aspect ratio may be measured according to the test method described in the Examples section below.

The composition of the present invention comprises an isocyanate composition comprising one or more polyisocyanate and a thermally conductive filler composition (C). “Polyisocyanate” refers to any compound that contains two or more isocyanate groups. The polyisocyanate may comprise a monomeric diisocyanate, a polymeric isocyanate, an isocyanate prepolymer, or mixtures thereof. The polyisocyanates can be aromatic, aliphatic, araliphatic or cycloaliphatic polyisocyanates, or mixtures thereof. Preferred polyisocyanates are aromatic polyisocyanates. An aromatic polyisocyanate refers to a compound having at least one isocyanate group bonded to aromatic carbon atoms. Polyisocyanates in the isocyanate composition may have an average isocyanate functionality of 2.0 or more, 2.1 or more, 2.2 or more, or even 2.3 or more, and at the same time, 4.0 or less, 3.8 or less, 3.5 or less, 3.2 or less, 3.0 or less, 2.8 or less, or even 2.7 or less.

The isocyanate composition of the present invention may comprise one or more monomeric polyisocyanate. Examples of suitable monomeric diisocyanates include diphenylmethane diisocyanate (MDI), isophorone diisocyanate (IPDI), hexamethylene diisocyanate (HDI), tetramethylene-1,4-diisocyanate, cyclohexane-1,4-diisocyanate, hexahydrotolylene diisocyanate, 1-methoxyphenyl-2,4-diisocyanate, diphenylmethane-4,4′-diisocyanate, diphenylmethane-2,4′-diisocyanate, 4,4′-biphenylene diisocyanate, 3,3′-dimethoxy-4,4′-diphenyl diisocyanate, and 3,3′-dimethyldiphenylpropane-4,4′-diisocyanate; isomers thereof, or mixtures thereof. Preferred monomeric diisocyanate is MDI.

The isocyanate composition of the present invention may comprise one or more isocyanate-terminated prepolymer. Isocyanate-terminated prepolymers can be any prepolymers prepared by reaction of one or more polyol with a stoichiometric excess of one or more polyisocyanate. The isocyanate-terminated prepolymer may comprise a polyether backbone and isocyanate moieties. The isocyanate-terminated prepolymer may have an isocyanate content of 5% or more, 6% or more, 8% or more, or even 10% or more, and at the same time, 30% or less, 25% or less, 20% or less, or even 15% or less, by weight based on the weight of the isocyanate-terminated prepolymer. The isocyanate (NCO) content herein is measured according to ASTM D5155-19. The isocyanates used to prepare the isocyanate-terminated prepolymers including the above stated monomeric diisocyanates, isomers thereof, polymeric derivatives thereof, or mixtures thereof. Preferred isocyanates are diphenylmethane diisocyanate (MDI), polymeric derivatives thereof, or mixtures thereof. MDI used to prepare the isocyanate-terminated prepolymer may be 4,4′-, 2,4′- or 2,2′-diphenylmethane diisocyanate, or mixtures thereof. A mixture of 2,4′-diphenylmethane diisocyanate and 4,4′-diphenylmethane diisocyanate may also be used. The polyols used to prepare the isocyanate-terminated prepolymer may be any polyols known in the art, including, for example, ethylene glycol, 1,2-propanediol, 1,3-propanediol, 1,3-butanediol, 1,4-butenediol, 1,4-butynediol, 1,5-pentanediol, neopentyl-glycol, bis(hydroxymethyl) cyclohexanes such as 1,4-bis(hydroxymethyl)cyclohexane, 2-methylpropane-1,3-diol, methylpentanediols, diethylene glycol, triethylene glycol, tetraethylene glycol, polyethylene glycol, dipropylene glycol, polypropylene glycol, dibutylene glycol, polybutylene glycols, polyoxyethylene glycols, polyoxypropylene glycols, polyoxypropylene-polyoxyethylene glycols, or mixtures thereof. Preferred polyols are polyether polyols described in the polyol composition section above.

The isocyanate composition of the present invention may also comprise polymeric derivatives of the monomeric diisocyanate described above, such as polymeric methylene diphenyl diisocyanate (“polymeric MDI”). Polymeric MDI may be a mixture of diphenylmethane diisocyanate and polyphenylene polymethylene polyisocyanates. Polymeric MDI useful in the present invention may contain from 2.5 to 3.5 isocyanate groups per molecule and have an isocyanate equivalent weight of from 130 to 150 or from 132 to 140. Suitable commercially available polymeric MDI products may include, for example, PAPI™ 27 and PAPI 32 polymeric MDI both available from The Dow Chemical Company (PAPI is a trademark of The Dow Chemical Company).

The thermally conductive filler composition (C) useful in the present invention comprises three different thermally conductive fillers: (c1), (c2) and (c3).

The (c1) thermally conductive fillers are spherical metal oxide particles. Spherical particles refer to particles with an aspect ratio of 0.8 or more, for example, 0.81 or more, 0.82 or more, 0.85 or more, 0.86 or more, 0.88 or more, 0.89 or more, 0.9 or more, 0.91 or more, 0.92 or more, 0.93 or more, 0.94 or more, or greater than 0.95 to 1.0, preferably, greater than 0.9. The spherical metal oxide particles are desirably selected from aluminum oxide particles, magnesium oxide particles, zinc oxide particles, and mixtures thereof. Preferred spherical metal oxides are aluminum oxide particles, magnesium oxide particles, or mixtures thereof. The spherical metal oxide particles (c1) may optionally be surface treated, for example, with an alkyl trialkoxysilane including those used for preparing surface treated metal oxide particles (c2), described below.

The spherical metal oxide particles (c1) useful in the present invention have a mean particle size of 20 μm or more. “Mean particle size” in the present invention refers to a D50 particle size as measured according to the test method described in the Examples section below. The spherical metal oxide particles (c1) have a mean particle size (D50) of 20 μm or more, 22 μm or more, 25 μm or more, 28 μm or more, 30 μm or more, 32 μm or more, or even 35 μm or more, and at the same time are typically 60 μm or less, 58 μm or less, 55 μm or less, 52 μm or less, 50 μm or less, 48 μm or less, 45 μm or less, 42 μm or less, or even 40 μm or less. The spherical metal oxide particles (c1) may be present in the isocyanate composition in an amount of 20% or more, 22% or more, 25% or more, 28% or more, 30% or more, 32% or more, 35% or more, 38% or more, 40% or more, 42% or more, 45% or more, 48% or more, 50% or more, 52% or more, 55% or more, or even 58% or more, and at the same time are typically present in an amount of 90% or less, 88% or less, 85% or less, 82% or less, 80% or less, 78% or less, 75% or less, 72% or less, 70% or less, or even 68% or less, by weight based on the weight of the isocyanate composition.

The (c2) thermally conductive fillers are surface treated metal oxide particles with one or more alkoxysilane, that is, metal oxide particles that have been surface treated by one or more alkoxysilane. The surface treated metal oxide particles (c2) after mixing with an aromatic isocyanate may contain a complex resulting from reaction and/or interaction of NCO groups in the isocyanate with functional groups on the surface of the metal oxide, such as NCO—O-metal oxide complex, at a concentration of at least 50% reduction of the concentration of the same complex formed by mixing the untreated metal oxide with the same isocyanate, as indicated by at least 50% reduction of the peak height ratio of the band at 1232 cm⁻¹ (—C═O absorbance in the complex) to the band at 2300 cm⁻¹ (free —NCO groups absorbance in the isocyanate) in the infrared spectrum, relative to such peak height ratio in the infrared spectrum of a mixture of the untreated metal oxide with the same isocyanate. Peak height ratio is determined by the test method described in the Examples section below.

The surface treated metal oxide particles (c2) useful in the present invention have a mean particle size (D50) of 10 μm or less, 9 μm or less, 8 μm or less, 7 μm or less, 6 μm or less, 5 μm or less, 4 μm or less, 3 μm or less, or even 2.5 μm or less, and at the same time, greater than 1 μm or are typically 1.1 μm or more, 1.2 μm or more, 1.3 μm or more, 1.4 μm or more, 1.5 μm or more, 1.6 μm or more, 1.7 μm or more, 1.8 μm or more, 1.9 μm or more, or even 2.0 μm or more. The surface treated metal oxide particles (c2) are typically non-spherical. Non-spherical particles refer to particles with an aspect ratio less than 0.8, for example, 0.7 or less, 0.6 or less, 0.5 or less, or even 0.4 or less.

The alkoxysilanes useful in forming the surface treated metal oxide particles (c2) are those that can react with functional groups (e.g., —OH groups) on metal oxide (untreated) to form a covalent bond such as -M-O—Si—C—, where M is the metal in the metal oxide. The alkoxysilanes useful in forming the surface treated metal oxide (that is, the alkoxysilanes used for treating metal oxide) may include an alkyl trialkoxysilane, an alkyl dialkoxysilane, a vinyl trialkoxysilane, a vinyl dialkoxysilane, or mixtures thereof, preferably, an alkyl trialkoxysilane. The alkoxysilanes may have the general formula of R¹Si(OR²)₃ or R¹R³Si(OR²)₂, where R¹ can be an alkyl or alkylene group having from 1 to 12 carbon atoms, from 1 to 8 carbon atoms, or from 1 to 4 carbon atoms; each R² is independently methyl, ethyl, or a combination thereof; and R³ can be an alkyl group having from 1 to 12 carbon atoms, from 1 to 8 carbon atoms, or from 1 to 4 carbon atoms. Specific examples of alkoxysilanes used in preparing surface treated metal oxide particles (c2) include methyltrimethoxysilane, n-decyltrimethoxysilane, ethyltrimethoxysilane, methyl tris(methoxyethoxy) silane, pentyltrimethoxy silane, hexyltrimethoxy silane, and octyltrimethoxysilane; vinyltrimethoxysilane, vinyltriethoxysilane, and vinylmethyldimethoxysilane; or mixtures thereof. The surface treated metal oxide particles (c2) can be surface treated aluminum oxide particles, surface treated zinc oxide particles, or mixtures thereof. The surface treated metal oxide particles (c2) may be present in the isocyanate composition in an amount of 10% or more, 12% or more, 15% or more, 17% or more, 19% or more, or even 20% or more, and the same time, 40% or less, 38% or less, 35% or less, 32% or less, 30% or less, 28% or less, or even 25% or less, by weight based on the weight of the isocyanate composition.

The (c3) thermally conductive fillers are one or more additional thermally conductive filler selected from one or a combination of more than one of these following two types of thermally conductive fillers: (c3-a) metal oxide particles with a mean particle size of 1 μm or less, and (c3-b) a thermally conductive filler with a thermal conductivity of 40 W/mK or more that is not a metal oxide particle (that is, that is other than a metal oxide particle). The metal oxide particles (c3-a) have a mean particle size (D50) of 1 μm or less, 0.9 μm or less, 0.8 μm or less, 0.7 μm or less, 0.6 μm or less, 0.5 μm or less, 0.4 μm or less, 0.3 μm or less, or even 0.25 μm or less, while at the same time are typically 0.1 μm or more, 0.11 μm or more, 0.12 μm or more, 0.13 μm or more, 0.14 μm or more, or even 0.15 μm or more. The thermally conductive filler (c3-b) may comprise any one or any combination of more than one type of particle selected from metal nitride particles, non-metal nitride particles, or mixtures thereof. The thermally conductive filler (c3-b) has a thermal conductivity of 40 W/mK or more, 41 W/mK or more, 42 W/mK or more, 43 W/mK or more, 44 W/mK or more, 45 W/mK or more, and at the same time is typically 300 W/mK or less, 250 W/mK or less, 240 W/mK or less, 230 W/mK or less, 220 W/mK or less, 210 W/mK or less, 200 W/mK or less, 80 W/mK or less, 79 W/mK or less, 78 W/mK or less, 75 W/mK or less, 72 W/mK or less, or even 70 W/mK or less. Preferably, the thermal conductivity of the thermally conductive filler (c3-b) is less than 80 W/mK. Thermal conductivity can be measured according to the test method described in the Examples section below. The thermally conductive filler (c3-b) may have a mean particle size (D50) of 1 μm or more, 2 μm or more, 3 μm or more, 4 μm or more, 5 μm or more, 6 μm or more, 7 μm or more, 8 μm or more, 9 μm or more, or even 10 μm or more, while at the same time is typically 50 μm or less, 48 μm or less, 45 μm or less, 42 μm or less, 40 μm or less, 38 μm or less, 35 μm or less, 32 μm or less, or even 30 μm or less. The additional thermally conductive filler (c3) may comprise any one or any combination of more than one type of particle selected from aluminum nitride (AlN) particles, zinc oxide (ZnO) particles, and boron nitride (BN) particles. Preferred additional thermally conductive fillers (c3) are zinc oxide particles, boron nitride particles, or mixtures thereof.

The additional thermally conductive filler (c3) may be present in the isocyanate composition in an amount of 1.5% or more, 1.6% or more, 1.7% or more, 1.75% or more, 2% or more, 3% or more, 4% or more, 5% or more, 5.5% or more, 5.8% or more, 6% or more, 6.2% or more, 6.5% or more, 6.8% or more, or even 7% or more, while at the same time is typically present in an amount of 12% or less, 11.5% or less, 11% or less, 10.5% or less, 10% or less, 9% or less, or even 8% or less, by weight based on the weight of the isocyanate composition. For example, zinc oxide particles may be present in an amount of zero or more, 5.5% or more, 5.8% or more, 6% or more, 6.2% or more, 6.5% or more, 6.8% or more, or even 7% or more, and at the same time are typically present in an amount of 12% or less, 11.5% or less, 11% or less, 10.5% or less, or even 10% or less, by weight based on the weight of the isocyanate composition. Boron nitride particles may be present in an amount of zero or more, 1.5% or more, 1.6% or more, 1.65% or more, 1.7% or more, 1.75% or more, 1.8% or more, 1.85% or more, 1.9% or more, 1.95% or more, and at the same time are typically present in an amount of 4% or less, 3.5% or less, 3.0% or less, 2.5% or less, 2.4% or less, 2.2% or less, 2.1% or less, or even 2.0% or less, by weight based on the weight of the isocyanate composition.

The isocyanate composition useful in the present invention may further comprise a thermally conductive filler (c4) that is different from (c1), (c2) and (c3). The thermally conductive filler (c4) is untreated metal oxide particles with a mean particle size (D50) of greater than 1 μm to less than 20 μm, for example, 18 μm or less, 15 μm or less, 12 μm or less, 10 μm or less, 9 μm or less, 8 μm or less, 7 μm or less, 6 μm or less, 5 μm or less, 4 μm or less, 3 μm or less, or even 2.5 μm or less, and at the same time, greater than 1.0 μm or are typically 1.1 μm or more, 1.2 μm or more, 1.3 μm or more, 1.4 μm or more, 1.5 μm or more, 1.6 μm or more, or even 1.7 μm or more. “Untreated” means the filler does not comprise a surface treating agent. Preferably, the untreated metal oxide particles (c4) have a mean particle size of less than 10 μm. The untreated metal oxide particles (c4) can be spherical particles, non-spherical particles, or combinations thereof. Preferably, the untreated metal oxide particles (c4) are untreated aluminum oxide particles, and more preferably, non-spherical untreated aluminum oxide particles. The isocyanate composition may comprise the untreated metal oxide particles (c4) in an amount of from zero to 4%, for example, 3.8% or less, 3.5% or less, 3.2% or less, 3% or less, 2.5% or less, 2% or less, 1.5% or less, 1% or less, or even 0.5% or less, by weight based on the weight of the isocyanate composition. Preferably, thermally conductive fillers in the isocyanate composition consist of (c1), (c2), and (c3).

The total concentration of thermally conductive fillers in the isocyanate composition may be greater than 87%, for example, 87.5% or more, 88% or more, 88.5% or more, or even 89% or more, and at the same time, 92% or less, 91.5% or less, 91% or less, 90.5% or less, 90% or less, or even 89.5% or less, by weight based on the total weight of the isocyanate composition. The isocyanate composition, particularly when comprising thermally conductive fillers in a total amount of greater than 87% of the isocyanate composition, is storage stable, as indicated by a viscosity drift of 50% or less or 45% or less after storage at 50° C. for 24 hours under nitrogen atmosphere. The infrared spectrum of the isocyanate composition may demonstrate a peak height ratio of the band at 1232 cm⁻¹ to the band at 2300 cm⁻¹ of 0.17 or less, 0.16 or less, 0.15 or less, 0.14 or less, 0.13 or less, or even 0.12 or less. The bands for determining the peak height ratio are as defined in the section of the surface treated metal oxide particles (c2) above. Viscosity drift and peak height ratio are determined according to the test methods described in the Examples section below.

The composition of the present invention can be a two-component curable composition that further comprises a polyol composition. The two-component curable composition comprises the polyol composition as a component A (also referred to as part A or A side) and the isocyanate composition as a component B (also referred as part B or B side). The polyol composition useful in the present invention comprises one or more polyether polyol. The polyether polyol in the polyol composition may have an average functionality of greater than 2.0 (>2.0). Average functionality refers to the average number of hydroxyl groups per molecule, i.e., total moles of OH groups divided by total moles of polyether polyols. The polyether polyol may have an average functionality of 2.1 or more, 2.2 or more, 2.3 or more, 2.4 or more, or even 2.5 or more, and at the same time, 4.0 or less, 3.9 or less, 3.8 or less, 3.7 or less, 3.6 or less, 3.5 or less, 3.4 or less, 3.2 or less, 3.1 or less, 3.0 or less, 2.9 or less, 2.8 or less, or even 2.7 or less.

The polyether polyol useful in the present invention may comprise one or more alkylene oxide unit in the backbone of the polyether polyol. The alkylene oxide units can be ethylene oxide, propylene oxide, or combinations thereof. The polyether polyols can be polyoxypropylene polyols, polyoxyethylene polyols, propylene oxide/ethylene oxide copolymer polyols, ethylene oxide-capped polyether polyols, or mixtures thereof. The polyether polyols may be initiated with, for example, water, organic dicarboxylic acids such as succinic acid, adipic acid, phthalic acid, terephthalic acid; or polyhydric alcohols (such as dihydric to pentahydric alcohols or dialkylene glycols), for example, ethanediol, 1,2- and 1,3-propanediol, diethylene glycol, dipropylene glycol, 1,4-butanediol, 1,6-hexanediol, glycerol, trimethylolpropane, pentaerythritol, sorbitol, and sucrose or blends thereof; linear and cyclic amine compounds which may also contain a tertiary amine such as ethanoldiamine, triethanoldiamine, and various isomers of toluene diamine, methyldiphenylamine, aminoethylpiperazine, ethylenediamine, N-methyl-1,2-ethanediamine, N-methyl-1,3-propanediamine, N,N-dimethyl-1,3-diaminopropane, N,N-dimethylethanolamine, diethylene triamine, bis-3-aminopropyl methylamine, aniline, aminoethyl ethanolamine, 3,3-diamino-N-methylpropylamine, N,N-dimethyldipropylenetriamine, aminopropyl-imidazole and mixtures thereof; or a combination of at least two of them. Preparation of the ethylene oxide-capped polyether polyols is well-known in the art and generally includes polymerization of propylene oxide using a hydroxyl- or amine-containing initiator, followed by capping with ethylene oxide.

The polyether polyol useful in the present invention may have an average hydroxyl number of from 5 to 500 milligrams potassium hydroxide per gram sample (mg KOH/g) or from 50 to 400 mg KOH/g, according to ASTM D4274-16. The polyether polyols may have an average equivalent weight of 140 or more, 200 or more, 300 or more, 400 or more, or even 500 or more, and at the same time, 8,000 or less, 4,000 or less, 3,000 or less, 2,000 or less, or even 1,000 or less. Equivalent weight is the weight of a polyol per reactive site. Equivalent weight is calculated by 56000/(OH number in mg KOH/g).

The polyether polyol useful in the present invention may comprise a glycerol propoxylated polyether polyol, a propylene glycol initiated homopolymer polyol, or mixtures thereof. Examples include VORANOL™ CP450 polyol (VORANOL is a trademark of The Dow Chemical Company) and VORANOL 1000LM polyol both available from The Dow Chemical Company.

The polyol composition useful in the present invention may comprise the polyether polyol in an amount of 20% or more, 25% or more, 30% or more, 35% or more, 40% or more, 45% or more, or even 50% or more, and at the same time, 100% or less, 90% or less, 85% or less, 80% or less, 75% or less, 70% or less, 65% or less, or even 60% or less, by weight based on the total weight of polyols in the polyol composition.

The polyol composition useful in the present invention may comprise one or more polyester polyol. The polyester polyol can be an aromatic polyester polyol. Polyester polyols can be reaction products of polycarboxylic acids or their anhydrides with polyhydric alcohols. The polycarboxylic acids or anhydrides may be aliphatic, cycloaliphatic, aromatic and/or heterocyclic. Examples of suitable polycarboxylic acids and anhydrides thereof include oxalic acid, malonic acid, succinic acid, glutaric acid, adipic acid, pimelic acid, suberic acid, azelaic acid, sebacic acid, maleic acid, fumaric acid, glutaconic acid, α-hydromuconic acid, β-hydromuconic acid, α-butyl-α-ethyl-glutaric acid, α,β-diethylsuccinic acid, isophthalic acid, terephthalic acid, hemimellitic acid, and 1,4-cyclohexane-dicarboxylic acid; anhydrides thereof such as phthalic anhydride; or mixtures thereof. The polyhydric alcohol can be aliphatic or aromatic. Examples of suitable polyhydric alcohols include ethylene glycol, 1,3-propylene glycol, 1,2-propylene glycol, 1,4-butylene glycol, 1,3-butylene glycol, 1,2-butylene glycol, 1,5-pentane diol, 1,4-pentane diol, 1,3-pentane diol, 1,6-hexane diol, 1,8-octane diol, neopentyl glycol, cyclohexane dimethanol, 1,7-heptane diol, glycerol, 1,1,1-trimethylolpropane, 1,1,1-trimethylolethane, hexane-1,2,6-triol, α-methyl glucoside, pentaerythritol, quinitol, mannitol, sorbitol, sucrose, methyl glycoside, diethylene glycol, triethylene glycol, tetraethylene glycol, dipropylene glycol, dibutylene glycol or blends thereof. Also included are compounds derived from phenols such as 2,2-(4,4′-hydroxyphenyl)propane, commonly known as bisphenol A, bis(4,4′-hydroxyphenyl)sulfide, and bis-(4,4′-hydroxyphenyl)sulfone. The polyester polyols may also include hybrid polyester polyols, for example, reaction products of polyester polyols with an alkoxylating agent such as propylene oxide. Examples of suitable hybrid polyester polyols include reaction products of phthalic anhydride, the polyhydric alcohol such as diethylene glycol, and propylene oxide.

The polyol composition useful in the present invention may comprise the polyester polyol in an amount of zero or more, 0.1% or more, 0.5% or more, 1% or more, 1.5% or more, 2% or more, 3% or more, 4% or more, 5% or more, or even 6% or more, and at the same time, 20% or less, 18% or less, 15% or less, 12% or less, 10% or less, or even 8% or less, by weight based on the total weight of polyols in the polyol composition.

The polyol composition useful in the present invention may comprise one or more natural vegetable oil polyol, derivatives thereof, or mixtures thereof including, for example, castor oil. These polyols may be present in an amount of zero or more, 5% or more, 10% or more, 15% or more, or even 20% or more, and at the same time, 50% or less, 45% or less, 40% or less, 35% or less, or even 30% or less, by weight based on the total weight of polyols in the polyol composition.

The polyol composition useful in the present invention may comprise one or more chain extender having two isocyanate reactive groups and a hydrocarbon backbone. The chain extenders typically have a molecular weight of 200 grams per mole (g/mol) or less, for example, from 80 to 120 g/mol. “Isocyanate reactive group” herein includes any active hydrogen containing moiety such as —OH and —SH. The backbone may further comprise one or more heteroatom. The heteroatoms in the backbone can be oxygen, sulfur, or a mixture thereof. The chain extenders may include diols, particularly a linear or branched diol with 9 or less carbon atoms. Examples of suitable chain extenders include ethane diol, propane diol, butane diol, hexane diol, heptane diol, octane diol, neopentyl glycol, or mixtures thereof. The chain extender may be present in an amount of from zero or more, 1% or more, 2% or more, 3% or more, or even 5% or more, and at the same time, 20% or less, 18% or less, 15% or less, 12% or less, or even 10% or less, by weight based on the total weight of polyols in the polyol composition.

The polyol composition useful in the present invention may comprise one or more polyoxyalkylene polyamine having 2 or greater amines per polyamine, from 2 to 4 amines per polyamine, or from 2 to 3 amines per polyamine, for example, JEFFAMINE amine terminated polyethers available from Huntsman Corporation. The polyoxyalkylene polyamine may be present in an amount of zero or more, 5% or more, or even 10% or more, and at the same time, 40% or less, 30% or less, or even 20% or less, by weight based on the total weight of the polyol composition excluding thermally conductive fillers.

The polyol composition useful in the present invention may comprise any one or any combination of the following thermally conductive fillers: the spherical metal oxide particles (c1), the surface treated metal oxide particles (c2), the additional thermally conductive filler (c3), and the untreated metal oxide particles (c4). The polyol composition may comprise (c1), (c2) and (c3), and optionally (c4). Alternatively, the polyol composition may comprise (c1), (c3) and (c4) such as non-spherical untreated metal oxide particles, and optionally (c2). Thermally conductive fillers in the polyol composition can be the same as or different from the thermally conductive fillers in the isocyanate composition. The polyol composition may comprise the spherical metal oxide particles (c1) in an amount of zero or more, 20% or more, 22% or more, 25% or more, 28% or more, 30% or more, 32% or more, 35% or more, 38% or more, 40% or more, 42% or more, 45% or more, 48% or more, 50% or more, 52% or more, 55% or more, or even 58% or more, and at the same time, 90% or less, 88% or less, 85% or less, 82% or less, 80% or less, 78% or less, 75% or less, 72% or less, 70% or less, or even 68% or less, by weight based on the weight of the polyol composition. The polyol composition may comprise the surface treated metal oxide particles (c2) in an amount of zero or more, 5% or more, 10% or more, 12% or more, 15% or more, 17% or more, 19% or more, or even 20% or more, and the same time, 40% or less, 38% or less, 35% or less, 32% or less, 30% or less, 28% or less, or even 25% or less, by weight based on the weight of the polyol composition. The polyol composition may comprise the additional thermally conductive filler (c3) in an amount of 1.5% or more, 1.6% or more, 1.7% or more, 1.75% or more, 2% or more, 3% or more, 4% or more, 5% or more, 5.5% or more, 5.8% or more, 6% or more, 6.2% or more, 6.5% or more, 6.8% or more, or even 7% or more, while at the same time is typically present in an amount of 12% or less, 11.5% or less, 11% or less, 10.5% or less, 10% or less, 9% or less, or even 8% or less, by weight based on the weight of the polyol composition. The polyol composition may comprise zinc oxide particles, as the additional thermally conductive filler (c3), in an amount of zero or more, 5.5% or more, 5.8% or more, 6% or more, 6.2% or more, 6.5% or more, 6.8% or more, or even 7% or more, and at the same time, 12% or less, 11.5% or less, 11% or less, 10.5% or less, or even 10% or less, by weight based on the weight of the polyol composition. The polyol composition may comprise boron nitride particles, as the additional thermally conductive filler (c3), in an amount of zero or more, 1.5% or more, 1.6% or more, 1.65% or more, 1.7% or more, 1.75% or more, 1.8% or more, 1.85% or more, 1.9% or more, 1.95% or more, and at the same time, 4% or less, 3.5% or less, 3.0% or less, 2.5% or less, 2.4% or less, 2.2% or less, 2.1% or less, or even 2.0% or less, by weight based on the weight of the polyol composition. The polyol composition may comprise the untreated metal oxide particles (c4) in an amount of zero or more, 5% or more, 10% or more, 12% or more, 15% or more, or even 20% or more, and the same time, 40% or less, 38% or less, 35% or less, 32% or less, or even 30% or less, by weight based on the weight of the polyol composition.

The two-component curable composition of the present invention comprises thermal conductive fillers in a total amount of greater than 87%, for example, 87.5% or more, 88% or more, 88.5% or more, or even 89% or more, and at the same time, 92% or less, 91.5% or less, 91% or less, 90.5% or less, 90% or less, or even 89.5% or less, by weight based on the total weight of the two-component curable composition. For example, the two-component curable composition may comprise the spherical metal oxide particles (c1) in a total amount of 20% or more, 22% or more, 25% or more, 28% or more, 30% or more, 32% or more, 35% or more, 38% or more, 40% or more, 42% or more, 45% or more, 48% or more, 50% or more, 52% or more, 55% or more, or even 58% or more, and at the same time, 90% or less, 88% or less, 85% or less, 82% or less, 80% or less, 78% or less, 75% or less, 72% or less, 70% or less, or even 68% or less, by weight based on the total weight of the two-component curable composition. The two-component curable composition may comprise the surface treated metal oxide particles (c2) in a total amount of 10% or more, 12% or more, 15% or more, 17% or more, 19% or more, or even 20% or more, and the same time, 40% or less, 38% or less, 35% or less, 32% or less, 30% or less, 28% or less, or even 25% or less, by weight based on the total weight of the two-component curable composition.

The additional thermally conductive filler (c3) may be present in the two-component curable composition in an amount sufficient to provide a desirable viscosity and satisfactory thermal conductivity as defined above, for example, in a total amount of 1.5% or more, 1.6% or more, 1.7% or more, 1.75% or more, 2% or more, 3% or more, 4% or more, 5% or more, 5.5% or more, 5.8% or more, 6% or more, 6.2% or more, 6.5% or more, 6.8% or more, or even 7% or more, while at the same time is typically present in an amount of 12% or less, 11.5% or less, 11% or less, 10.5% or less, 10% or less, 9% or less, or even 8% or less, by weight based on the total weight of the two-component curable composition. When the additional thermally conductive filler (c3) comprises zinc oxide particles, the total concentration of zinc oxide particles in the two-component curable composition may be 5.5% or more, 5.8% or more, 6% or more, 6.2% or more, 6.5% or more, 6.8% or more, or even 7% or more, and at the same time, 12% or less, 11.5% or less, 11% or less, 10.5% or less, or even 10% or less, by weight based on the total weight of the two-component curable composition. When the additional thermally conductive filler (c3) comprises boron nitride particles, the total concentration of boron nitride particles in the two-component curable composition may be 1.5% or more, for example, 1.6% or more, 1.65% or more, 1.7% or more, 1.75% or more, 1.8% or more, 1.85% or more, 1.9% or more, 1.95% or more, and at the same time, 4% or less, 3.5% or less, 3.0% or less, 2.5% or less, 2.4% or less, 2.2% or less, 2.1% or less, or even 2.0% or less, by weight based on the total weight of the two-component curable composition.

The two-component curable composition of the present invention may comprise the untreated metal oxide particles (c4) in a total amount of zero or more, 5% or more, 10% or more, 12% or more, 15% or more, or even 20% or more, and the same time, 40% or less, 38% or less, 35% or less, 32% or less, or even 30% or less, by weight based on the weight of the two-component curable composition.

The weight ratio of total thermally conductive fillers in the polyol composition to total thermally conductive fillers in the isocyanate composition in the two-component curable composition may be zero or more or may be in the range of from 0.90 to 1.20, for example, 0.91 or more, 0.92 or more, 0.93 or more, 0.94 or more, 0.95 or more, 0.96 or more, 0.97 or more, 0.98 or more, 0.99 or more, or even 1.0 or more, and at the same time, 1.18 or less, 1.15 or less, 1.12 or less, 1.10 or less, 1.08 or less, 1.05 or less, 1.04 or less, 1.03 or less, 1.02 or less, or even 1.01 or less. Such weight ratio of thermally conductive fillers in the two components of the curable composition allows the volume ratio of the polyol component and polyisocyanate component to be prepared within a range of 0.95 to 1.05, and enables the curable composition to be prepared by using conventional processing facilities for mixing the two components—the polyol composition and the isocyanate composition. Therefore, the mixing equipment for preparing each component of the curable composition can be at the same size without involving special equipment design to reach other mixing ratios required by conventional two-component curable polyurethane compositions. The weight ratio of total fillers in the polyol composition to total fillers in the isocyanate composition can be the same as the above stated weight ratios, i.e., the weight ratios of total thermally conductive fillers in the two components of the curable composition.

Surprisingly, it was found that the weight ratio of thermally conductive fillers with a mean particle size of 20 μm or more to thermally conductive fillers with a mean particle size of 10 μm or less in the two-component curable composition or in each of the polyol composition and the isocyanate composition (“weight ratio of large to small fillers”) within a certain range can significantly improve flowability of the two-component curable composition without compromising thermal conductivity properties. For example, the weight ratio of large (greater than 20 micrometers) to small (10 micrometers or less) fillers in the curable composition or in each of the polyol composition and the isocyanate composition can be 2.0 or more, for example, 2.05 or more, 2.1 or more, 2.2 or more, 2.3 or more, 2.4 or more, or even 2.45 or more, and at the same time, 4.0 or less, 3.9 or less, 3.8 or less, 3.7 or less, or even 3.6 or less. The weight ratio of the spherical metal oxide particles (c1) to the surface treated metal oxide particles (c2) in the thermally conductive filler composition (C) can be in the same ranges as the weight ratio of large to small fillers, for example, in the range of 2.0 to 4.0. Significantly improved flowability herein refers to a viscosity being 150 Pa·s or less at room temperature, for example, 140 Pa·s or less, 130 Pa·s or less, 120 Pa·s or less, 110 Pa·s or less, 100 Pa·s or less, 90 Pa·s or less, or even 80 Pa·s or less at room temperature, as measured within 30 minutes after mixing the two components of the curable composition according to the test method described in the Examples section below.

The two-component curable composition of the present invention may comprise one or more organosilane, which is useful to adjust the viscosity without compromising curing strength of the curable composition. The curing strength of the two-component curable composition can be 0.5 megapascal (MPa) or more, 0.6 MPa or more, or even 0.7 MPa or more, as determined according to the test method described in the Examples section below. The organosilanes may be present in the polyol composition and/or the isocyanate composition. The organosilanes may include silanes having the formula of RSi(OR₂)₃ or RR₃Si(OR₂)₂, where R can be an organic group, preferably an alkyl group, having from 1 to 12 carbon atoms, from 1 to 8 carbon atoms, or from 1 to 4 carbon atoms, which can optionally contain a functional organic group such as, for example, mercapto, epoxy, acryl, and methacryl; or a silyl terminated dimethylsiloxane group having the structure of Me₃SiO(SiMe₂O)n-, where n can be an integer of from 1 to 10 or from 1 to 4; each R₂ is independently methyl, ethyl, or combinations thereof; and R₃ can be an alkyl group having from 1 to 12 carbon atoms, from 1 to 8 carbon atoms, or from 1 to 4 carbon atoms. The organosilanes may include one or more alkyl trialkoxysilane such as an alkyl trimethoxysilanes, an epoxy functional alkoxysilane, or mixtures thereof.

Suitable organosilanes useful in the present invention may include, for example, alkyl trialkoxysilanes such as n-decyltrimethoxysilane, methyltrimethoxysilane, ethyltrimethoxysilane, pentyltrimethoxy silane, hexyltrimethoxy silane, octyltrimethoxysilane, and methyl tris(methoxyethoxy) silane; (meth)acryl functional alkoxysilanes such as 3-methacryloxypropyltrimethoxysilane, 3-methacryloxypropylmethyldimethoxysilane, and 3-methacryloxypropyldimethylmethoxysilane; epoxy functional alkoxysilanes such as 3-glycidoxypropyltrimethoxysilane, 3-glycidoxypropylmethyl dimethoxysilane, 2-(3,4-epoxycyclohexyl) ethyl trimethoxy silane, 2-(3,4-epoxycyclohexyl) ethylmethyl dimethoxysilane, 4-oxiranylbutyitrirnethoxy silane, 4-oxiranylbutyitriethoxysilane, 4-oxiranyibutylmethyldimethoxy silane, 8-oxiranyioctyitrimethoxysilane, 8-oxiranyloctyltriethoxysilane, and 8-oxiranyloctylmethyidimethoxy silane; mercapto functional alkoxysilanes such as 3-mercaptopropyltrimethoxy silane and 3-mercaptopropylmethyidimethoxy silane; or mixtures thereof. Preferred organosilanes include n-decyltrimethoxysilane, glycidoxypropyltrimethoxysilane, or mixtures thereof.

The two-component curable composition of the present invention may comprise the organosilane in an amount of from zero to 20%, for example, 5% or more, 6.5% or more, 7% or more, 8% or more, 9% or more, 10% or more, 11% or more, or even 12% or more, and at the same time, 20% or less, 19% or less, 18% or less, 17% or less, 16% or less, 15% or less, or even 14% or less, by weight based on the total weight of the two-component curable composition.

The two-component curable composition of the present invention may comprise one or more catalyst for the reaction of isocyanate functional groups with isocyanate reactive groups. The catalysts may be present in the polyol composition, the isocyanate composition or both. The catalysts may be any one or any combination of more than one selected from organotin compounds, metal alkanoates, tertiary amines and diazabicyclo compounds. Examples of suitable organotin catalysts include alkyl tin oxides such as dibutyl tin oxide, stannous alkanoates such as stannous octoate, dialkyl tin carboxylates and tin mercaptides. Preferred organotin catalyst is a dialkyltin dicarboxylate or a dialkyltindimercaptide. Examples of suitable metal alkanoates include bismuth octoate, bismuth neodecanoate, or mixtures thereof. Examples of suitable tertiary amines include dimorpholinodialkyl ether, a di((dialkylmorpholino)alkyl)ether such as (di-(2-(3,5-dimethyl-morpholino)ethyl)ether), bis-(2-dimethylaminoethyl)ether, triethylene diamine, pentamethyldiethylene triamine, N,N-dimethylcyclohexylamine, N,N-dimethyl piperazine, 4-methoxyethyl morpholine, N-methylmorpholine, N-ethyl morpholine, or mixtures thereof. The catalyst may be present in an amount of from 0.006% to 5.0%, from 0.01% to 2.0%, or from 0.02% to 1.0%, by weight based on the total weight of the two-component curable composition.

In addition to the components described above, the two-component curable composition of the present invention may further comprise one or more of the following additives: fillers other than thermally conductive fillers, pigments, adhesion promoters, plasticizers, stabilizers such as ultraviolet stabilizers, flame retardants, and antioxidants. These additives may be present in the polyol composition and/or the isocyanate composition in a total amount of from zero to 10%, 0.1% to 5%, or 0.5% to 1%, by weight based on the total weight of the two-component curable composition.

The two-component curable composition useful in the present invention has good processability, as indicated by a low viscosity at room temperature, for example, a viscosity of 230 Pa·s or less, 210 Pa·s or less, 200 Pa·s or less, 190 Pa·s or less, 180 Pa·s or less, 170 Pa·s or less, 160 Pa·s or less, 150 Pa·s or less, or even 140 Pa·s or less at room temperature. Preferably, the two-component curable composition has a viscosity of 150 Pa·s or less at room temperature. Viscosities herein are measured within 30 minutes after mixing the polyol and polyisocyanate components (components A and B) of the curable composition, according to the test method described in the Examples section. The two-component curable composition is thermally conductive and, upon curing, forms a polyurethane material (that is, a cured composition) with a high thermal conductivity. “High thermal conductivity” in the present invention means a thermal conductivity of 2.73 W/mK or more, and preferably 3.0 W/mK or more, as measured according to the test method described in the Examples section below.

The present invention also relates to a process for preparing the composition of the present invention, comprising admixing the polyisocyanate with the thermally conductive filler (C).

The present invention also provides a process for preparing the two-component curable composition, comprising admixing the polyol composition with the isocyanate composition, and optionally components described above, to form the curable composition. The polyol composition and the isocyanate composition can be combined such that the molar ratio of isocyanate groups to isocyanate reactive groups may be in the range of from 0.95:1 to 1.1:1, from 0.96:1 to 1.05:1, or from 1:1 to 1.02:1. At the same time, the volume ratio of the polyol composition to the isocyanate composition in the curable composition may be controlled within the range between 0.95:1 to 1.05:1, from 0.96:1 to 1.04:1, from 0.97:1 to 1.03:1, from 0.98:1 to 1.02:1, or from 0.99:1 to 1.01:1, or at the ratio of 1:1. Such volume ratios (that is, consistent mixing ratios) indicate the two-component curable composition can be prepared using existing processing facilities for conventional two-component polyurethane compositions. The weight ratio of total thermally conductive fillers in the polyol composition to total thermally conductive fillers in the isocyanate composition may be in the range as described above, preferably in the range of from 0.95 to 1.05.

The two components of the curable composition are reactive with one another and when contacted or mixed upon application have adhesive properties and undergo a curing reaction wherein the reaction product of the two components is a cured product which is capable of bonding certain substrates together. The two-component curable composition is useful as a gap filler or an adhesive for electronic vehicles. The two-component curable composition is particularly suitable for filling the space between the encasing, supporting, or framing plastic metal, or glass and the liquid-crystal display element of a liquid-crystal projector, liquid-crystal television, liquid-crystal display, or other liquid crystal device; as filling materials between the encasing, supporting, or framing plastic or glass and a fluorescent display tube; and as filling materials between a power battery cell and the encasing, supporting, or framing plastic metal or glass. The high thermal conductivity described above makes the curable composition useful in the present invention is particularly suitable for use as gap fillers or adhesives for electric vehicle applications such as in assemblies of energy storage devices.

The present invention also provides a method of bonding a first substrate to a second substrate. The method comprises (i) admixing the isocyanate composition with the polyol composition to form the two-component curable composition, (ii) applying the two-component curable composition to the surface of at least one of the substrates, (iii) contacting the two substrates with the curable composition residing therebetween, and (iv) curing the curable composition. The two substrates useful in the present invention may be same or different. One of the two substrates may be plastics, metals, alloys, glass or composites. The surface of the substrate can be surface treated prior to application of the composition of the present invention. Any known surface treatment means which increase the number of polar groups present on the surface of the substrates such as plastics may be used, including corona discharge, and chemical etching. Generally, the two-component curable composition is applied at ambient temperature (for example, from 23 to 35° C.) in the presence of atmospheric moisture. The curable composition after curing forms a durable bond between the substrates. The curing of the curable composition can be conducted at ambient temperature or at an elevated temperature (for example, up to 80° C.). The curing of the curable composition may be further accelerated by applying convection heat, infrared irradiation, induction heating, microwave heating, and/or enhancing the amount of moisture in the atmosphere such as by using a humidity chamber.

### EXAMPLES

Some embodiments of the invention will now be described in the following Examples, wherein all parts and percentages are by weight unless otherwise specified. The following materials are used in the examples:

DAM-40K spherical alumina (Al₂O₃) filler, available from Denka Company Limited, has a D50 particle size of 40 μm, an aspect ratio >0.9, and a thermal conductivity of 30 w/mk.

DAM-40K surface treated spherical alumina filler treated by a silane, available from Denka Company Limited, has a D50 particle size of 40 μm, an aspect ratio >0.9, and a thermal conductivity of 30 W/mk.

MARTOXID™ TM2320 alkoxysilane pre-treated alumina filler, available from Huber Company, has a D50 particle size of 2 μm, an aspect ratio <0.8, and a thermal conductivity of 30 W/mK (MARTOXID is a trademark of Martinswerk GmbH).

P662SB alumina filler, available from Alteo Co., has a D50 particle size of 1.7 μm, an aspect ratio <0.8, and a thermal conductivity of 30 W/mk.

Zinc oxide (ZnO) filler, available from ALCAN Co., has a D50 particle size of 0.2 μm. and a thermal conductivity of 45 W/mK.

BN PW-30 boron nitride (BN) filler, available from Zibo Jonye Tech Ceramic Co., has a D50 particle size of 20 μm and a thermal conductivity of 70 W/mK.

Castor oil, available from Fisher Aldrich, is an oil-based polyol.

1,4-butanediol (BDO), available from Fisher Aldrich, is used as a chain extender.

STEPANPOL™ PDP-70 hybrid polyol, available from Stephan, is an ester modified, di-functional polyether polyol (OH number: 70 mg KOH/g) (STEPANPOL is a trademark of Stepan Company).

Molecule Sieve 3 Å is available from Grace.

The following materials are all available from The Dow Chemical Company.

VORANOL™ CP450 polyol is a glycerine propoxylated multi-functional polyether polyol with a functionality of 3 and a OH number: 380 mg KOH/g.

VORANOL 1000LM polyol is a di-functional polyether polyol with a OH content of 2.0 mmol/g.

DOWSIL™ Z-6040 silane is glycidoxypropyltrimethoxysilane.

DOWSIL Z-6210 silane is n-Decyltrimethoxysilane.

VORANOL 1045K isocyanate prepolymer, polyether-MDI prepolymer (NCO content: 10-12% by weight, functionality: 2).

ISONATE™ 50 O,P′ Pure MDI (MDI-50) is a diphenylmethane diisocyanate.

PAPI™ 27 isocyanate is a polymeric MDI with an equivalent weight 137 g/mol and a functionality of 2.7.

DOWSIL, ISONATE and PAPI are all trademarks of The Dow Chemical Company.

The following standard analytical equipment and methods are used in the Examples and in determining the properties and characteristics stated herein:

### Thermal Conductivity

Determine thermal conductivity according to ISO 22007-2. Two-component polyurethane compositions were cured in an oven at 50° C. for 24 hours to form cured samples. The thermal conductivity of the cured samples was measured by Hot Disk 5465 with a 3.189 mm Kapton sensor (Heat power: 350 mW, time: 5 seconds, drift correction enabled, using fine-tuned analysis, and plots from 50 to 150). Each sample was evaluated for three times and the average value of thermal conductivity was calculated.

### Mean Particle Size and Aspect Ratio of Fillers

Determine mean particle size, i.e., D50 particle size, and aspect ratio of fillers using Laser Diffraction particle size analyzer from Beckman Coulter (Model LS 13 320) by averaging particle size of 1,500 particles.

### Viscosity Test of Two-Component Curable Composition

Two components (that is, part A and part B) of a test two-component curable composition were mixed using SpeedMixer DAC 600.2 VAC provided by FlackTek Inc. (at 2,000 revolutions per minute (rpm) under vacuum (20 kilopascals) for 30 seconds. The viscosity of the resultant mixture was measured within 30 minutes after the mixing. Determine viscosities of samples using ARES G2 using 25 millimeters (mm) parallel plates with a gap of 0.6 mm. The flow sweep was conducted from 0.01 to 10 s⁻¹. Viscosities at 1 s⁻¹ at room temperature were recorded.

### Curing Strength Test

A test two-component polyurethane composition was cured at room temperature for at least 72 hours. The resultant cured sample was cut into type 1A specimens and tensile strength was evaluated according to International Organization for Standards ISO527 standard (most current as of the priority date of this document).

### Density and Volume Ratio Measurement

The density of a test formulation was measured using 37 milliliter (ml) standard density cup (PhysiTest 14001 provided by EPK Co.) according to International Organization for Standards ISO 2811 standard (most current as of the priority date of this document). The weight of the empty density cup was recorded as W1 in gram. Then the test formulation was filled into the cup and the weight of the filled up was recorded as W2 in gram. Density in g/ml is calculated as,

Density=(W2−W1)/37.

Volume ratio of Part A to Part B is measured by:

Volume ratio (A/B)=Density of Part B/Density of Part A.

### Viscosity Drift and Reflection Fourier Transform Infrared (FTIR) Spectroscopy of Isocyanate Compositions

Isocyanate compositions comprising fillers were prepared by well mixing the fillers with PAPI 27 polymeric MDI at filler loadings of 20% to 50%, by weight based on the weight of the isocyanate, using a speed mixer at 2,000 rpm for 2 minutes. Viscosities of the obtained isocyanate compositions were measured and recorded as “viscosity (t0)”. Then the isocyanate compositions were purged with nitrogen and stored in an oven at 50° C. for 24 hours when viscosities of the isocyanate compositions were measured and recorded as “viscosity (t24)”, followed by centrifugation to remove the top liquid at 4,000 rpm for 30 min. The resulting sediments were measured using reflection FTIR (Perkin Elmer Spectrum 100) to get the IR absorption spectrum. The ratio of the peak height of the absorbance at 1232 cm⁻¹ to the peak height of the absorbance at 2300 cm⁻¹ in the IR spectrum was calculated. Viscosity drift was determined by viscosity (t0)/viscosity (t24). Determine viscosities of samples using ARES G2 using 25 millimeters (mm) parallel plates with a gap of 0.6 mm. The flow sweep was conducted from 0.01 to 10 s⁻¹. Viscosities at 1 s⁻¹ at room temperature were recorded.

### Examples (Exs) 1-10 and Comparative (Comp) Exs 1-3 Polyurethane Compositions

Preparation of Resin Mixture A: All materials in the Resin Mixture A listed in Table 1-1 were added into a vial (“vial A”) and mixed using a SpeedMixer (Flektex Inc) at 2,000 rpm for 3 minutes to give the Resin Mixture A. The vial A was then sealed.

Preparation of Resin Mixture B: All materials in the Resin Mixture B listed in Table 1-2 were added into another vial (“vial B”) and mixed by using the SpeedMixer at 2,000 rpm for 3 minutes to give the Resin Mixture B. The vial B was then sealed.

According to polyurethane compositions given in Table 2-1 and 2-2, thermally conductive fillers in Part A were added into the Resin Mixture A and mixed using the SpeedMixer at 2,000 rpm for 5 minutes under vacuum to give the Part A. The vial A was then sealed. Thermally conductive fillers in Part B were added into the Resin Mixture B and mixed using the SpeedMixer at 2,000 rpm for 5 minutes under vacuum to give the Part B. The vial B was then sealed. The obtained Part A and Part B were cooled down to room temperature, and then mixed using the SpeedMixer at 2,000 rpm for 2 minutes under vacuum in a separate vial to give polyurethane compositions, which were then sealed in the vial. The obtained polyurethane compositions were evaluated for thermal conductivity and curing strength properties according to the test methods described above and results are given in Tables 2-1 and 2-2.

As shown in Table 2-1, all of the polyurethane compositions of Exs 1-10 had desirably low viscosities (≤230 Pa·s) while providing thermal conductivities of 2.73 W/mK or more. Among Exs 1-10, the polyurethane compositions of Exs 1-6 and 8-9 demonstrated even better balance of high thermal conductivity (>3.0 W/mK) and low viscosity (<150 Pa·s at room temperature), as compared to Ex 7 with the filler weight ratio of (c1)/(c2) being 0.975 or Ex 10 with lower content of BN. Moreover, the polyurethane compositions of Exs 1-10 also had volume ratios of Part A/Part B in the range of from 0.95 to 1.05 and can be handled using conventional polyurethane processing facilities. In contrast, as shown in Table 2-2, the polyurethane composition of Comp Ex 1 with a total filler loading of 87% (by weight based on the total weight of the polyurethane composition) provided poorer thermal conductivity. The polyurethane composition of Comp Ex 2 free of ZnO and BN provided poorer thermal conductivities. The polyurethane composition of Comp Ex 3 using P662SB untreated Al₂O₃ to replace TM2320 pre-treated Al₂O₃ showed undesirably high viscosity.

TABLE 1-1
Formulation of Resin Mixture A

| Materials | gram |
|---|---|
| VORANOL CP450 polyol | 14.63 |
| Castor oil | 24.39 |
| VORANOL LM1000 polyol | 24.39 |
| BDO | 4.88 |
| STEPANPOL PDP-70 polyol | 4.88 |
| DOWSIL Z-6040 silane | 4.88 |
| DOWSIL Z-6210 silane | 9.76 |
| Molecule sieve | 12.20 |

TABLE 1-2
Formulation of Resin Mixture B

| Materials | gram |
|---|---|
| VORANOL 1045K isocyanate prepolymer | 58.54 |
| MDI | 29.27 |
| DOWSIL Z-6210 silane | 12.20 |

TABLE 2-1
Polyurethane Adhesive Compositions

| | | | Ex | Ex | Ex | Ex | Ex | Ex | Ex | Ex | Ex | Ex |
|---|---|---|---|---|---|---|---|---|---|---|---|---|
| Materials, gram | | | 1 | 2 | 3 | 4 | 5 | 6 | 7 | 8 | 9 | 10 |
| Part | Resin Mixture A | | 5.5 | 5.5 | 6 | 5.5 | 5.5 | 5.5 | 6 | 5.5 | 6 | 5.5 |
| A | Filler | DAM-40K | 0 | 29.5 | 0 | 0 | 31 | 26.5 | 0 | 0 | 0 | 34 |
| | in | Treated (c1) | | | | | | | | | | |
| | part | DAM-40K | 29.5 | 0 | 30.5 | 34 | 0 | 0 | 19.5 | 30.75 | 29 | 0 |
| | A | (c1) | | | | | | | | | | |
| | | TM2320 | 10 | 10 | 12.5 | 9.63 | 12.5 | 0 | 20 | 10.25 | 10 | 9.75 |
| | | (c2) | | | | | | | | | | |
| | | P662SB | 0 | 0 | 0 | 0 | 0 | 13 | 0 | 0 | 0 | 0 |
| | | (c4) | | | | | | | | | | |
| | | ZnO (c3) | 5 | 5 | 0 | 0 | 0 | 5 | 5 | 3.5 | 5 | 0 |
| | | BN (c3) | 0 | 0 | 1 | 0.88 | 1 | 0 | 0 | 0 | 0 | 0.75 |
| Part | Resin Mixture B | | 5.5 | 5.5 | 6 | 5.5 | 5.5 | 5.5 | 6 | 5.5 | 6 | 5.5 |
| B | Filler | DAM-40K | 0 | 29.5 | 0 | 0 | 31 | 26.5 | 0 | 0 | 0 | 34 |
| | in | Treated (c1) | | | | | | | | | | |
| | part | DAM-40K | 29.5 | 0 | 30.5 | 34 | 0 | 0 | 19.5 | 30.75 | 29 | 0 |
| | B | (c1) | | | | | | | | | | |
| | | TM2320 | 10 | 10 | 12.5 | 9.63 | 12.5 | 13 | 20 | 10.25 | 10 | 9.75 |
| | | (c2) | | | | | | | | | | |
| | | ZnO (c3) | 5 | 5 | 0 | 0 | 0 | 5 | 5 | 3.5 | 5 | 0 |
| | | BN (c3) | 0 | 0 | 1 | 0.88 | 1 | 0 | 0 | 0 | 0 | 0.75 |

| | | | | | | | | | | |
|---|---|---|---|---|---|---|---|---|---|---|
| Calculation | | | | | | | | | | |
| Weight ratio large/ | 2.95 | 2.95 | 2.44 | 3.53 | 2.48 | 2.04 | 0.975 | 2.95 | 2.9 | 3.48 |
| small fillers, | | | | | | | | | | |
| (c1)/[(c2) + (c4)] | | | | | | | | | | |
| Total filler loading, | 89 | 89 | 88 | 89 | 89 | 89 | 88 | 89 | 88 | 89 |
| % by weight | | | | | | | | | | |
| Weight ratio of fillers | 1 | 1 | 1 | 1 | 1 | 1 | 1 | 1 | 1 | 1 |
| in part A to | | | | | | | | | | |
| fillers in part B | | | | | | | | | | |
| Volume ratio of | 1.04 | 1.04 | 1.04 | 1.04 | 1.04 | 1.04 | 1.04 | 1.04 | 1.04 | 1.04 |
| part A/part B | | | | | | | | | | |
| Abs (density | 0.1 | 0.1 | 0.1 | 0.1 | 0.1 | 0.1 | 0.1 | 0.1 | 0.1 | 0.1 |
| A-density B) | | | | | | | | | | |
| Properties | | | | | | | | | | |
| Thermal conductivity, | 3 | 3 | 3 | 3.1 | 3.4 | 3.07 | 3.02 | 3.1 | 3.05 | 2.73 |
| W/mK | | | | | | | | | | |
| Viscosity, Pa · s | 129 | 77 | 80 | 100 | 140 | 150 | 230 | 100 | 120 | 70 |
| Curing strength, MPa | 0.8 | 0.8 | 1.0 | 0.8 | 0.7 | 0.7 | 0.9 | 0.8 | 0.7 | 0.7 |

*Abs: absolute value

TABLE 2-2
Polyurethane Adhesive Compositions

| Materials, gram | | | Comp Ex 1 | Comp Ex 2 | Com Ex 3 |
|---|---|---|---|---|---|
| Part A | Resin Mixture A | | 6.5 | 5.5 | 5.5 |
| | Filler in | DAM-40K Treated (c1) | 0 | 29.5 | 0 |
| | part A | DAM-40K (c1) | 25.5 | 0 | 29.5 |
| | | TM2320 (c2) | 13 | 15 | 0 |
| | | P662SB (c4) | 0 | 0 | 10 |
| | | ZnO (c3) | 5 | 0 | 5 |
| | | BN (c3) | 0 | 0 | 0 |
| Part B | Resin Mixture B | | 6.5 | 5.5 | 5.5 |
| | Filler in | DAM-40K Treated (c1) | 0 | 29.5 | 0 |
| | part B | DAM-40K (c1) | 25.5 | 0 | 29.5 |
| | | TM2320 (c2) | 13 | 15 | 0 |
| | | P662SB (c4) | 0 | 0 | 10 |
| | | ZnO (c3) | 5 | 0 | 5 |
| | | BN (c3) | 0 | 0 | 0 |

| | | | |
|---|---|---|---|
| Calculation | | | |
| Weight ratio large/small fillers, (c1)/[(c2) + (c4)] | 1.96 | 1.97 | 2.95 |
| Total filler loading, % by weight | 87 | 89 | 89 |
| Weight ratio of fillers in part A to fillers in part B | 1 | 1 | 1 |
| Volume ratio of part A/part B | 1.04 | 1.04 | 1.04 |
| Abs (density A-density B) | 0.1 | 0.1 | 0.1 |
| Properties | | | |
| Thermal conductivity, W/mK | 2.59 | 2.39 | 2.87 |
| Viscosity, Pa · s | 61 | 60 | 289 |

Isocyanate compositions with different fillers at different loadings were prepared by mixing the fillers with an aromatic polyisocyanate (pMDI) and evaluated for viscosity drift and peaks changes in the IR spectra after storage at 50° C. for 24 hours, according to the test method described above. Results are given in Table 3. The peak height at 2300 cm⁻¹ in the IR spectrum corresponds to the amount of free NCO groups. The peak height at 1232 cm⁻¹ in the IR spectrum corresponds to the amount of a complex formed by NCO groups with the fillers. Since only the sediments were used for the IR spectrum analysis, the peak height ratio (1232 cm⁻¹/2300 cm⁻¹) stands for the fraction of isocyanate groups that have reacted with the fillers in isocyanate residues absorbed by the fillers (unreacted NCO groups). As shown in Table 3, isocyanate compositions 1-6 comprising the aromatic polyisocyanate and fillers including BN, pre-treated Al₂O₃, and/or ZnO all demonstrated lower viscosity drift and less reaction between fillers and the polyisocyanate as indicated by smaller IR peak ratios (1232 cm⁻¹/2300 cm⁻¹) (e.g., 0.12 or less), as compared to the isocyanate composition 7 comprising untreated Al₂O₃.

TABLE 3
Viscosity drift and reflection FTIR results for isocyanate compositions

| | | | IR Peak |
|---|---|---|---|
| | | | height ratio |
| | Fillers and loading (by weight | Viscosity drift | (1232 cm⁻¹/ |
| | based on the isocyanate weight) | (50° C., 24 hours) | 2300 cm⁻¹) |
| Isocyanate | 12.5% TM2320 pre-treated Al₂O₃, | 35% | 0.11 |
| composition 1 | 31% DAM-40K Treated (pretreated | | |
| | spherical Al₂O₃), and 1% BN | | |
| Isocyanate | 10% TM2320 pre-treated Al₂O₃, | 42% | 0.13 |
| composition 2 | 29.5% DAM-40K spherical Al₂O₃, | | |
| | and 5% ZnO | | |
| Isocyanate | 12.5% TM2320 pre-treated Al₂O₃, | 37% | 0.12 |
| composition 3 | 30.5% DAM-40K spherical Al₂O₃, | | |
| | and 1% BN | | |
| Isocyanate | 20% BN | 30% | 0.08 |
| composition 4 | | | |
| Isocyanate | 20% TM2320 pre-treated Al₂O₃ | 40% | 0.12 |
| composition 5 | | | |
| Isocyanate | 50% TM2320 pre-treated Al₂O₃ | 37% | 0.11 |
| composition 6 | | | |
| Isocyanate | 20% P662SB untreated Al₂O₃ | 100% | 0.35 |
| composition 7 | | | |

What is claimed is:

1. A composition comprising an isocyanate composition comprising a polyisocyanate and a thermally conductive filler composition (C), wherein the thermally conductive filler composition comprises:
(c1) spherical metal oxide particles with a mean particle size of 20 μm or more;
(c2) surface treated metal oxide particles with a mean particle size of greater than 1 μm to 10 μm, wherein the surface treated metal oxide particles are treated by an alkoxysilane; and
(c3) an additional thermally conductive filler selected from the group consisting of metal oxide particles with a mean particle size of 1 μm or less, a thermally conductive filler with a thermal conductivity of 40 W/mK or more and that is other than a metal oxide particle, or mixtures thereof.

2. The composition of claim 1, wherein the total concentration of thermally conductive fillers in the isocyanate composition is greater than 87% by weight based on the weight of the isocyanate composition.

3. The composition of claim 1, wherein the surface treated metal oxide particles (c2) are treated by an alkyl trialkoxysilane, an alkyl dialkoxysilane, a vinyl trialkoxysilane, a vinyl dialkoxysilane, or mixtures thereof.

4. The composition of claim 1, wherein the surface treated metal oxide particles (c2) are surface treated aluminum oxide particles.

5. The composition of claim 1, wherein the weight ratio of the spherical metal oxide particles (c1) to the surface treated metal oxide particles (c2) in the thermally conductive filler composition (C) is in the range of from 2.0 to 4.0.

6. The composition of claim 1, wherein the additional thermally conductive filler (c3) comprises zinc oxide particles, boron nitride particles, or mixtures thereof.

7. The composition of claim 1, wherein the composition is a two-component curable composition that further comprises a polyol composition comprising one or more polyether polyol having an average functionality of greater than 2.0, wherein the total concentration of thermally conductive fillers in the curable composition is greater than 87% by weight based on the total weight of the curable composition.

8. The composition of claim 7, wherein the polyol composition comprises one or more of the following thermally conductive fillers: the spherical metal oxide particles (c1), the surface treated metal oxide particles (c2), the additional thermally conductive filler (c3), and (c4) untreated metal oxide particles with a mean particle size of greater than 1 μm to less than 20 μm.

9. The composition of claim 7, wherein zinc oxide particles as the additional thermally conductive filler (c3) are present in the curable composition in a total amount of 5.5% or more, by weight based on the total weight of the curable composition.

10. The composition of claim 7, wherein boron nitride particles as the additional thermally conductive filler (c3) are present in the curable composition in a total amount of 1.5% or more, by weight based on the total weight of the curable composition.

11. The composition of claim 7, wherein the two-component curable composition further comprises from 6.5% to 20% of an alkyl trialkoxysilane, an epoxy functional alkoxysilane, or mixtures thereof, by weight based on the total weight of the curable composition.

12. The composition of claim 7, wherein the volume ratio of the polyol composition to the isocyanate composition is between 0.95 to 1.05.

13. The composition of claim 7, wherein the weight ratio of total thermally conductive fillers in the polyol composition to total thermally conductive fillers in the isocyanate composition is in the range of from 0.95 to 1.05.

14. The composition of claim 1, wherein the isocyanate composition comprises an aromatic polyisocyanate.

15. A process for preparing the composition of claim 1, comprising admixing the components of the thermally conductive filler composition (C) with the polyisocyanate.
